(19) United States
(12) Patent Application Publication
(10) Pub. No.: US 2010/0066901 A1
(43) Pub. Date: Mar. 18, 2010

(54) APPARATUS AND METHOD FOR PROCESSING VIDEO DATA

(75) Inventors: Anteneh A. ABBO, Eindhoven (NL); Richard P. KLEIHORST, Neerpelt (BE); Om Prakash GANGWAL, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/574,420

(22) PCT Filed: Sep. 6, 2005
(86) PCT No.: PCT/IB05/52901

§ 371 Date: Feb. 28, 2007

(30) Foreign Application Priority Data
Sep. 8, 2004 (GB) 0419870.1

(51) Int. Cl. H04N 7/01

(52) U.S. Cl. 348/448; 348/E07.003

(57) ABSTRACT

A SIMD processor architecture comprises a Linear Processor Array (LPA) (41) having a plurality of Processing Elements (PEs) (42). Each PE (42) operates on its pixel data based on a common instruction which is broadcast to all PEs (42) from a global control processor (44). To enhance the processor's capability in handling de-interlacing algorithms, there is provided a field access module (FAM) (47), an input line memory (48), and a shadow memory (49) within a working line memory (43). The input line memory (48) comprises a previous video field memory (481) for storing a first plurality of pixels from a previous video field, a current video field memory (482) for storing a plurality of pixels from a current video field and a next video field memory (483) for storing a plurality of pixels from a next video field. In a similar manner, the shadow memory (49) comprises a previous-copy video field memory (491), a current-copy video field memory (492), and a next-copy video field memory (493). The provision of the separate memories allows the processing elements to access the previous, current and next video field data simultaneously, thereby improving the efficiency of the de-interlacing operation.

### FIELD OF THE INVENTION

The invention relates to an apparatus and method for processing video data, and in particular to a single instruction multiple data (SIMD) processor that is adapted for processing de-interlacing algorithms.

### BACKGROUND OF THE INVENTION

Video signals come in different frame-rates, thus making video format conversion a core task in almost all video processing apparatus. For example, movie pictures are recorded at 24, 25 or 30 Hz, while TV signals are interlaced at either 50 Hz or 60 Hz. In addition to this, modern displays often work at higher display rates to reduce flickering (for example interlacing at 75 Hz, 90 Hz, 100 Hz, etc). In view of the above, video frame-rate conversion becomes an important functionality in bridging the dissimilar domains, including the displaying of interlaced TV signals on a computer monitor which is based on progressive scan.

De-interlacing is the task of calculating the odd lines from an even field and vice versa. On the low-end side of the performance scale are the algorithms that perform line repetition or line averaging (both of which are intra-field interpolation methods). On non-moving sequences the result of these algorithms suffers from the original 25 or 30 Hz line flickering. Another de-interlacing method is line insertion. Here the missing lines are copied from the same vertical position from the previous field (this is an inter-field interpolation method). On non-moving sequences this algorithm performs very well. However, even with just slightly moving sequences annoying artefacts become visible in the displayed image.

In the past decades, extensive work has been carried out to improve the quality of displayed video material via smart algorithms that have benefited from the growing computational power of integrated circuits. Known methods either provide dedicated ASICs to deal with the computational complexity of high-performance algorithms, or implement part of the algorithm on media processing integrated circuits, such as the applicant's TriMedia processor. Advanced frame-rate conversion techniques apply methods for motion compensation and direction-dependent (edge-dependent) de-interlacing to generate high-quality displayed images. On the high end of the performance scale are the motion compensation methods that use information from the past, shifted according to an appropriate motion vector. Edge-dependent de-interlacing is a method for effectively removing jagged edges from interlaced video. It detects and quantifies edges for optimal image interpolation, with applications in high-end as well as in economy interlacing. An example of advanced de-interlacing is disclosed in “IC for Motion-Compensated De-Interlacing, Noise reduction and Picture Rate Conversion” by G. de Haan, IEEE Transactions on CE, vol. 45, no. 3, August 1999.

FIG. 1 shows one example of an advanced de-interlacing algorithm. A video input signal 1 stored in a field memory 3 is processed using a basic de-interlacing function 5 in combination with an edge-dependent post processing function 7 to produce a video output signal 9. The combination of the basic de-interlacing function with edge-dependent post-processing enhances the quality of the de-interlaced image.

FIG. 2 shows a three field de-interlacing algorithm using data from a previous field 21, a next field 23 and a current field 25 to fill missing lines in the current field 25. The unshaded lines represent the missing image lines in the three fields 21, 23, 25. A majority select de-interlacing process computes the values of the missing lines in the current field 21 using data in “neighbouring” lines of all the three fields 21, 23, 25. For example, the data for missing line 25_{X} is calculated using data from lines 21_{Ap}, 21_{A} and 21_{An} in the previous field 21, data from lines 25_{B} and 25_{C} in the current field 25, and data from line 23_{D} in the next field 23.

FIGS. 3a and 3b show examples of the pseudo-codes for carrying out a majority-select median filtering for de-interlacing, and the Edge-dependent post processing functions, respectively. It is noted that a median filter de-interlacing algorithm combines the benefits of line repetition and line insertion, whereby pixels in missing lines are calculated by taking the median of two pixels from the neighbouring lines in the current field, and one pixel from the line on the same vertical position in the previous field. All of these high-end algorithms are computationally intensive and demand high performance figures.

Although it is known to implement such algorithms in parallel processing arrays, such systems do not make efficient use of the de-interlacing functions.

It is therefore the aim of the present invention to provide a SIMD processor that is adapted to process de-interlacing algorithms more efficiently.

### SUMMARY OF THE INVENTION

According to a first aspect of the present invention, there is provided a processor array for de-interlacing a video data signal, the processor array comprising: an array of processing elements for processing the video data signal to produce a de-interlaced video signal; a previous video field memory, the previous video field memory storing a first plurality of pixels from a previous video field; a current video field memory, the current video field memory storing a plurality of pixels from a current video field; and a next video field memory, the next video field memory storing a plurality of pixels from a next video field, wherein the processor array is configured such that the previous video field memory, the current video field memory and the next video field memory can be accessed simultaneously during a de-interlacing operation.

The architecture described above provides high performance, flexibility and low-power.

According to another aspect of the present invention, there is provided a method of de-interlacing a video data signal using a processor array having a plurality of processing elements for processing the video data signal to produce a de-interlaced video signal, the method comprising the steps of: storing a first plurality of pixels from a previous video field in a previous video field memory; storing a plurality of pixels from a current video field in a current video field memory; storing a plurality of pixels from a next video field in a next video field memory; and enabling the previous video field memory, the current video field memory and the next video field memory to be accessed simultaneously during a de-interlacing operation.

### BRIEF DESCRIPTION OF THE DRAWINGS

For a better understanding of the present invention, and to show more clearly how it may be carried into effect, reference will now be made, by way of example only, to the following figures in which:

FIG. 1 shows a schematic diagram of edge-dependent de-interlacing;

FIG. 2 shows a known three field de-interlacing algorithm;

FIG. 3a shows a typical pseudo code for majority-select median filtering for de-interlacing;

FIG. 3b shows a typical pseudo code for edge-dependent post processing;

FIG. 4 shows a processor array architecture adapted for de-interlacing according to the present invention; and

FIG. 5 shows a pipelined de-interlacing operation in a linear processor array of FIG. 4.

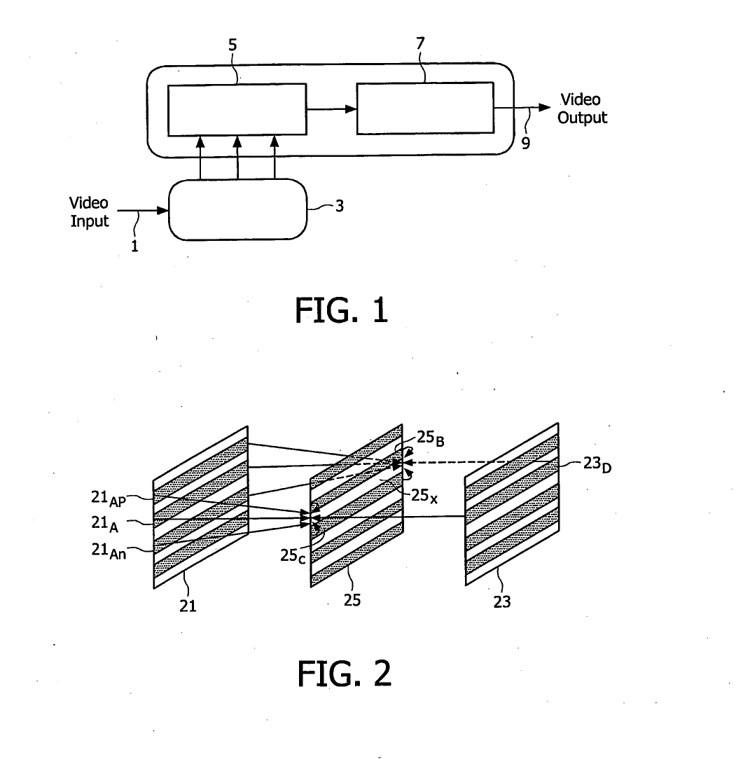

### DETAILED DESCRIPTION OF A PREFERRED EMBODIMENT OF THE PRESENT INVENTION

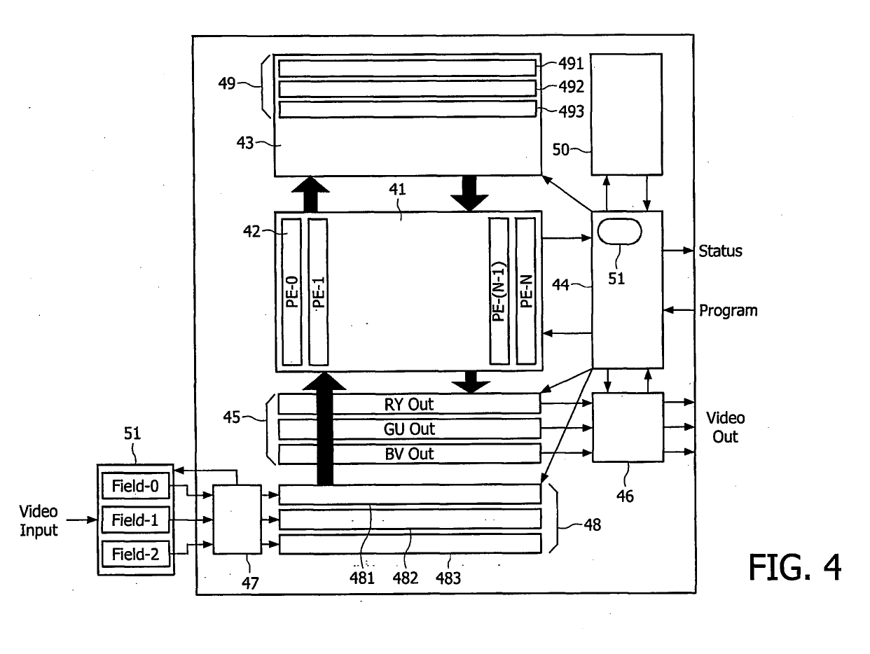

FIG. 4 shows a SIMD processor architecture according to the present invention for processing de-interlacing algorithms.

As with a conventional SIMD processor, the architecture comprises a Linear Processor Array (LPA) 41 having a plurality of Processing Elements (PEs) 42. The LPA 41 can have as many PEs 42 as the number of pixels in a line, for example. Each PE 42 operates on its pixel data based on a common instruction which is broadcast to all PEs 42 from a global control processor 44. The result of the LPA 41 is written in parallel to an output line memory 45. A serial processor 46 performs appropriate post processing (for example, format conversion and statistical processing) on the outgoing video data.

Depending on the chosen operating frequency, the LPA 41 can execute a pre-defined number of operations per image line. Due to the pixel-level parallelism, the same number of instructions are available for processing each pixel.

The global control processor 44 is responsible for the synchronization of the entire SIMD processor architecture. The main task of the global control processor 44 is to update the program counter, to fetch and decode instructions and pass them to the LPA 41. Additionally, the global control processor 44 can receive statistical information from the serial processor 46 and perform dynamic adaptation of filter coefficients, or can even control the flow of the actual program. The global control processor 44 also interfaces to the outside world for program downloading and communicating status information. These features are common in a SIMD processor architecture.

According to the present invention, the SIMD processor architecture described above is adapted to enable the processor to perform de-interlacing tasks more efficiently. The enhancements comprise a field access module (FAM) 47, an input line memory 48 and a shadow memory 49 within the working line memory 43. The input line memory 48 comprises a previous video field memory 481, a current video field memory 482 and a next video field memory 483. The previous video field memory 481 stores a first plurality of pixels from a previous video field, the current video field memory 482 stores a plurality of pixels from a current video field, and the next video field memory 483 stores a plurality of pixels from a next video field.

In a similar manner, the shadow memory 49 comprises a previous-copy video field memory 491, a current-copy video field memory 492, and a next-copy video field memory 493. The previous-copy video field memory 491 stores a first plurality of pixels from a previous copy of the video field, the current-copy video field memory 492 stores a plurality of pixels from a current-copy of the video field, and the next-copy video field memory 493 stores a plurality of pixels from a next copy of the video field.

The de-interlacing algorithm for operating on the received video signal, for example an edge-dependent de-interlacing algorithm, is stored in a program memory 50 together with other video processing codes, and operates on the three video fields, ie the previous, current and next video fields. The processing is conducted in a pipelined fashion in which the processor array operates on the shadow memories 491, 492, 493 while the input line memories 481, 482, 483 are being filled with new data. The architecture is easily scalable to match the desired area, speed and power dissipation trade-offs.

The field access module 47, input line memory 48 and shadow memory 49 work together to address the data preparation part for enabling the efficient utilization of the SIMD architecture for implementing de-interlacing algorithms. The field access module 47 is configured to provide an interface between a multi-port field memory 51 and the input line-memories 481, 482, 483 through proper addressing and synchronization. The field access module 47 takes care of the change of location of previous, current and next fields in the field memory 51.

The provision of an input line memory 48 in the form of a previous, current and next video field memories 481, 482 and 483 facilitates the simultaneous three-field access to the previous, current and next video fields by the linear processor array 41. Likewise, the storage of previous-copy, current-copy and next-copy memories 491, 492 and 493 enables simultaneous access to these memories by the linear processor array 41. Further details about how the input line memories 481, 482, 483 and the shadow memories 491, 492, 493 are utilized during a typical de-interlacing process will be provided below.

Thus, according to the processor architecture of the present invention, while the LPA 41 is busy preparing the next output line, the video input port and the serial processor are also busy receiving in and sending out video data, respectively.

To facilitate the use of the proposed architectural enhancements, the global control processor is preferably provided with a Shadow and Input Memory Sequencer (SIMS) module 51. The SIMS module 51 is a dedicated task that makes use of the index rotation unit of the global control processor 44 to manage the sequence and updating of the line-memory blocks during de-interlacing.

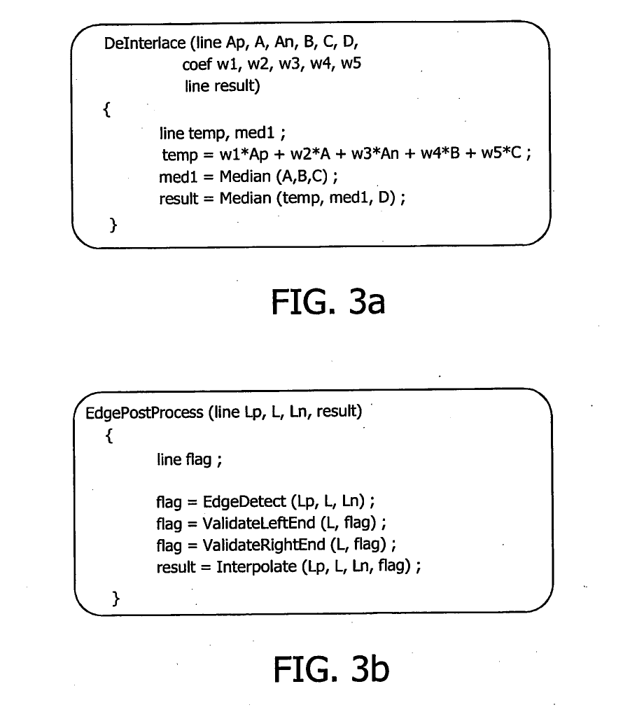

The field access module 47, input line memory 48 and shadow memory 49 exploit the performance of the SIMD architecture for performing de-interlacing tasks. For example, an implementation of the edge-based de-interlacing algorithm given in FIGS. 3a and 3b on the proposed architecture of FIG. 4 is completed in a total of 245 clock cycles (15 cycles for the basic de-interlacing function and 230 cycles for the edge-dependent post processing). It will be appreciated that the exact number of cycles will depend on a number of factors, including the video format and the number of PEs 42 in the LPA 41. For example, the cycle counts would be 15;230 for CIF, 30;460 for VGA, 60;920 for SVGA format, etc.

Even though the de-interlacing routine in FIG. 3a requires six input lines from the three fields to compute a missing line, the actual n umber of lines to be read out of the field memory 51 simultaneously is three. The remaining lines reside in the shadow memory 49.

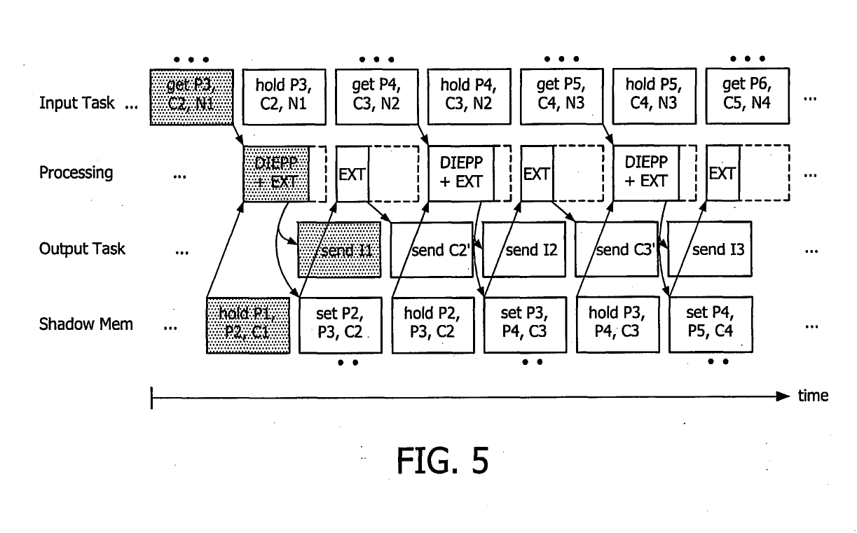

FIG. 5 shows the pipelined de-interlacing task in progress together with the contents and moments of updating of the input and shadow line-memories. The processing of a line has been classified as DIEPP (De-Interlacing and Edge Post Processing) for the missing line and EXT (Extra) common for all image lines. The shaded slice shows the steps needed to compute a single missing line [Mⱼ] in the current frame based on lines [Pⱼ, Pⱼ₊₁, Pⱼ₊₂] from the previous field, [Cⱼ, Cⱼ₊₁] from the current field and [Nⱼ] from the next field. The lines which are updated in the input and shadow line-memories are marked by the dark dots.

One of the features of the architecture is its flexibility originating from the programmability of the architecture. The actual pixel processing can be made adaptive to suit the dynamics of the video signal. Furthermore, the coefficients of the filters used or even the algorithmic flow can be altered on the fly.

The proposed approach results in high-performance and yet low-power, since the parallelism in data processing localizes data access and allows the use of a lower system clock frequency. Consequently, the switching power dissipation reduces.

Although the preferred embodiment has been described as having three field memories for processing data from current, previous and next fields, it will be appreciated that one or more field memories could be provided if data from another field or fields is being used in the processing operation. Likewise, fewer field memories could be used if fewer fields are used in the data processing.

Furthermore, although the preferred embodiment discloses the three field memories as being logically separate memories, it will be appreciated that the three field memories could be mapped to one memory with a wide interface to fulfill the bandwidth requirement.

It should be noted that the above-mentioned embodiments illustrate rather than limit the invention, and that those skilled in the art will be able to design many alternative embodiments without departing from the scope of the appended claims. The word ‘comprising’ does not exclude the presence of elements or steps other than those listed in a claim.

1. A processor array for de-interlacing a video data signal, the processor array comprising:
an array of processing elements for processing the video data signal to produce a de-interlaced video signal;
a previous video field memory, the previous video field memory storing a first plurality of pixels from a previous video field;
a current video field memory, the current video field memory storing a plurality of pixels from a current video field; and
a next video field memory, the next video field memory storing a plurality of pixels from a next video field,
wherein the processor array is configured such that the previous video field memory, the current video field memory and the next video field memory can be accessed simultaneously during a de-interlacing operation.

2. A processor array as claimed in claim 1, further comprising a field access module, the field access module being connected to a field memory that receives the video data signal to be de-interlaced, and adapted to provide an output signal to the previous video field memory, current video field memory and next video field memory, respectively.

3. A processor array as claimed in claim 2, wherein the field access module is adapted to deal with the change of location of previous, current and next video fields in the field memory.

4. A processor array as claimed in claim 1, further comprising a working line memory, the working line memory comprising:
a previous-copy video field memory, the previous-copy video field memory storing a first plurality of pixels from a previous copy of the video field;
a current-copy video field memory, the current-copy video field memory storing a plurality of pixels from a current-copy of the video field; and
a next-copy video field memory, the next-copy video field memory storing a plurality of pixels from a next copy of the video field.

5. A processor array as claimed in claim 1, further comprising a global control processor, the global control processor including means for controlling the memories.

6. A processor array as claimed in claim 5, wherein the means for controlling the memories is adapted to make use of an index rotation unit of the global control processor to manage the sequence and updating of the memories during de-interlacing.

7. A processor array as claimed in claim 1, wherein the plurality of field memories are logically separate memories.

8. A processor array as claimed in claim 1, wherein the plurality of field memories are mapped to one logical memory having a wide interface to meet the bandwidth requirement.

9. A processor array as claimed in claim 1, comprising one or more further memory means for storing data from one or more other fields used in the de-interlacing operation.

10. A method of de-interlacing a video data signal using a processor array having a plurality of processing elements for processing the video data signal to produce a de-interlaced video signal, the method comprising the steps of:
storing a first plurality of pixels from a previous video field in a previous video field memory;
storing a plurality of pixels from a current video field in a current video field memory;
storing a plurality of pixels from a next video field in a next video field memory; and enabling the previous video field memory, the current video field memory and the next video field memory to be accessed simultaneously during a de-interlacing operation.

11. A method as claimed in claim 10, further comprising the step of providing a field access module for connection to a field memory that receives the video data signal to be de-interlaced, and outputting data from the field access module to the previous video field memory, current video field memory and next video field memory.

12. A method a claimed in claim 10, further comprising the steps of:
storing a first plurality of pixels from a previous copy of the video field in a previous-copy video field memory;
storing a plurality of pixels from a current copy of the video field in a current-copy video field memory; and
storing a plurality of pixels from a next copy of the video field in a next-copy video field memory.

13. A method as claimed in claim 10, further comprising the step of providing a global control processor for controlling the memories.

14. A method as claimed in claim 13, further comprising the step of managing the sequence and updating of the memories during the de-interlacing operation using an index rotation unit of the global control processor.

15. A method as claimed in claim 10, wherein the step of accessing the previous video field memory, the current video field memory and the next video field memory during a de-interlacing operation comprises the steps of accessing a plurality of separate memories.

16. A method as claimed in claim 10, wherein the step of accessing the previous video field memory, the current video field memory and the next video field memory during a de-interlacing operation comprises the step of accessing a single memory having a wide interface.
